(19) United States
(12) Patent Application Publication
(10) Pub. No.: US 2007/0223222 A1
(43) Pub. Date: Sep. 27, 2007

(54) Warning ground lighting system

(76) Inventor: Hon Kwok Cheng, Hong Kong (HK)

Correspondence Address: RABIN & Berdo, PC, 1101 14TH STREET, NW, SUITE 500, WASHINGTON, DC, 20005, US

(21) Appl. No.: 11/471,585

(22) Filed: Jun. 21, 2006

(30) Foreign Application Priority Data
Mar. 27, 2006 (CN) 200620018531.4

(51) Int. Cl. F21V 21/00

(52) U.S. Cl. 362/249; 362/431; 362/251

(57) ABSTRACT

A warning ground lighting system is provided, comprising a controller, two groups of light strings each group having a plurality of light strings, conducting wires connecting said controller and said two groups of light strings, and a plurality of hollow supporting rods, each supporting rod serving for supporting a light holder which is connected with a light cap in a buckling manner. The conducting wires bring a plurality of lights together in series to form a light string in each group which is then positioned within the supporting rod and the light holder. A circuit of the lighting system is constructed by multiple output terminals of the controller coupled in parallel to the two groups of light strings with opposite phase order connected together. The invention can produce an excellent decorative effect with a remarkable warning purpose when located at the walkway.

### FIELD OF THE INVENTION

The present invention relates to a ground lighting system, and particularly to a novel warning ground lighting system.

### BACKGROUND OF THE INVENTION

In general, decorative lamps are individually provided for currently available ground lamp fixtures, without a chasing luminous effect given out by the decorative lamps. The lamps arranged at two sides of a road can not light-chase reciprocally in an opposite direction. The lamp fixtures arranged on the roofs of buildings, usually being water pipe lamps, produce a unidirectional chasing effect with less motion feeling in most cases. Designers must put more efforts into artificial modelings and colors in order to display various and wonderful styles.

The present invention is to provide a warning ground lighting system that has a totally new concept and design, essentially characterized in that it gives out a fantastic chasing luminous effect because two groups of light strings forming the lighting system synchronize their light-generation in the same direction or in the opposite direction, thus making the light become flashing colorful light and heightening the joyous and festive atmosphere.

### SUMMARY OF THE INVENTION

An object of the present invention is to provide a warning ground lighting system that is arranged at both sides of the walkway and generates a chasing effect in an unidirectional or a bi-directional manner for decorative purpose.

To attain this, the warning ground lighting system according to the invention comprises a controller, two groups of light strings each group having a plurality of light strings, and conducting wires connecting said controller and said two groups of light strings, characterized in that said light system further comprises a plurality of hollow supporting rods, each supporting rod serving for supporting a light holder which is connected with a light cap in a buckling manner, and wherein the conducting wires bring a plurality of lights together in series to form a light string in each group which is then positioned within the supporting rod and the light holder.

Each of said supporting rods is preferably linked to a ground stake via a joggle.

In one preferred embodiment of the invention, a circuit of said lighting system is constructed by multiple output terminals of the controller coupled in parallel to the two groups of light strings with opposite phase order connected together.

In one preferred embodiment of the invention, each group of light strings includes eight light strings, the controller has four output terminals, wherein every two strings in each group are connected each other in series and subsequently connected in parallel respectively and successively between one of the four output terminals of the controller and the zero line.

In one embodiment of the invention, each light string includes ten lights.

According to the invention, the two groups of light strings of the lighting system may be arranged respectively at two sides of the walkway and controlled by one controller having the output terminals which are connected in parallel to the two groups of light strings with opposite phase order, so that the two groups of light strings synchronize their light-generation either in the same direction or in the opposite direction to form a chasing of light, generating a running-horse effect that the two groups of light strings perform the identical action at their corresponding positions. The invention can produce a novel and excellent decorative effect with a remarkable warning purpose when located at the walkway.

The invention will now be described in more detail with reference to the accompanying figure drawings.

### BRIEF DESCRIPTION OF THE DRAWINGS

FIG. 1 is a pictorial view of the construction of the warning ground lighting system according to one embodiment of the invention.

FIG. 2 is an exploded view of one light string of the lighting system of the FIG. 1.

FIG. 3 is a schematic diagram of an example circuit used in the lighting system of FIG. 1.

### DETAILED DESCRIPTION OF THE INVENTION

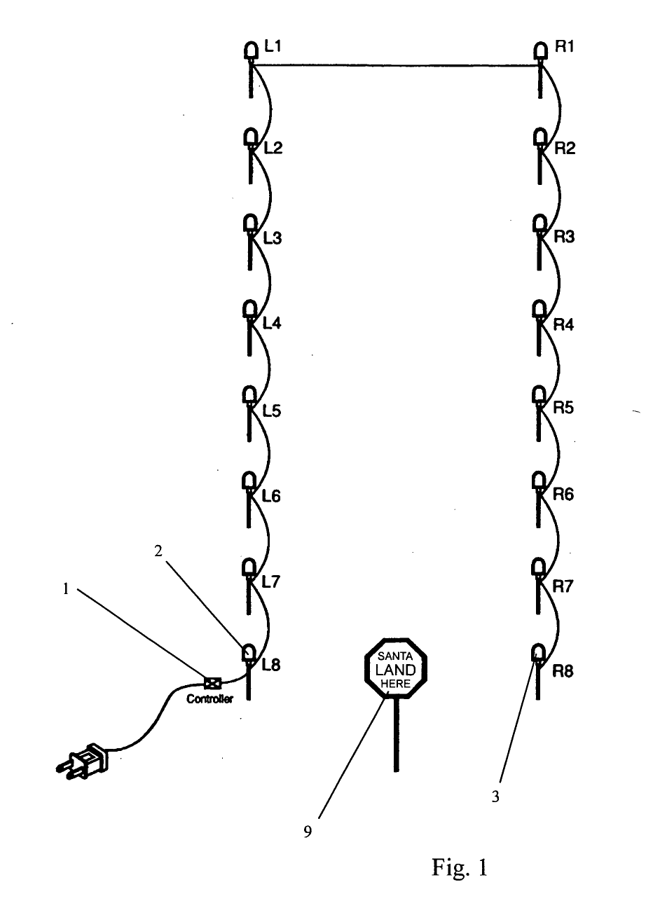

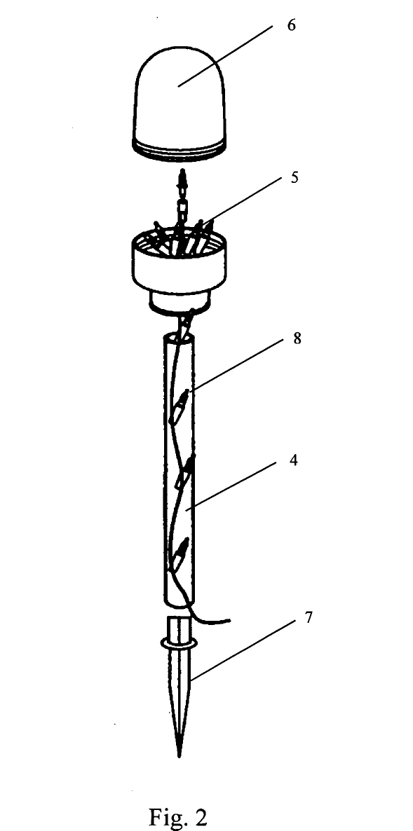

Referring to FIGS. 1 and 2, there is illustrated a warning ground lighting system, comprising a controller 1 and two groups of light strings 2, 3, all of which are connected through conducting wires. Each group of light strings has a plurality of light strings. The lighting system further comprises a plurality of hollow supporting rods 4 and a plurality of light holders 5 respectively connected with light caps 6 in a buckling manner, wherein one supporting rod 4 serves for supporting one light holder 5.

As clearly shown in FIG. 2, a plurality of lights 8 are connected together in series through the conducting wires to form a light string which is then positioned within the supporting rod 4 and the light holder 5. The supporting rod 4 is linked to a ground stake 7 via a joggle. When set up in the ground, the warning ground lighting system gives out a good caution effect. By use of such a light string structure, the invention generally produces soft light in a diffuse manner, has low power consumption and is convenient to use and maintain with reduced cost.

The joggle may be devised such that the ground stake 7 and the supporting rod 4 are respectively formed at one of their ends as cylinders that may be mutually-meshed, wherein the cylinder of the ground stake 7 is provided with a plurality of slots along its circumference and the interior of the cylinder of the supporting rod 4 is provided with a plurality of chips along its circumference at the positions where the chips correspond to the slots. When it is desirable to engage the supporting rod 4 and the ground stake 7, the chips may be received in the slots to form a stable connection.

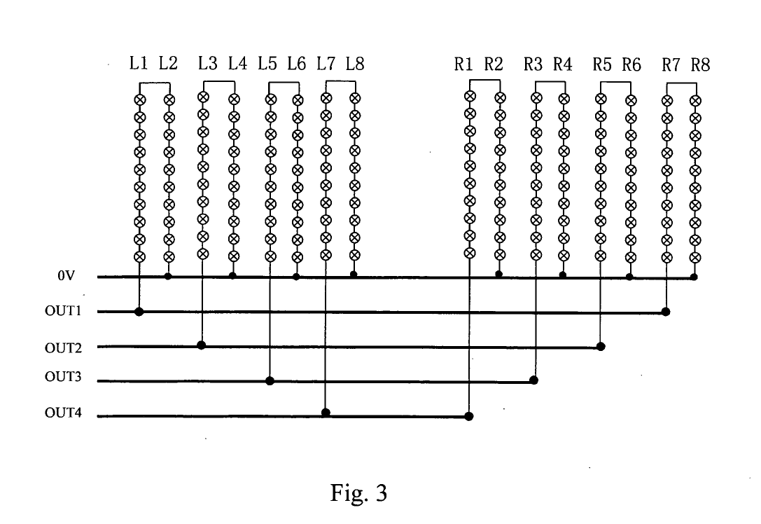

Referring now to FIG. 3, a circuit used in the warning ground lighting system of the invention is illustrated, which is constructed by four output terminals of the controller 1 and two groups of light strings L1-L8 and R1-R8. The output terminals and the groups of light strings are connected in parallel. As illustrated in FIG. 3, each group of light strings includes eight light strings L1-L8 or R1-R8, every two strings in each group are connected each other in series and subsequently connected in parallel respectively and successively between one of the four output terminals OUT1, OUT2, OUT3, OUT4 of the controller and the zero line OV. The two groups of light strings are connected together in an opposite phase order. Each light string has ten lights LED1-LED10 coupled in series.

The conventional circuits of pipe lamps or light strings may be used in the controller 1 of the invention. The controller 1 differs from the existing technology in that the output terminals of the controller 1 are connected in parallel to a second group of light strings in an opposite phase order so that synchronization of light given out by the two groups of light strings either in the same direction or in the opposite direction is attained at any position of the lighting system, thus serving for warning purpose when the lighting system is set up in the ground.

Also, a lamp box made of plastic or wood materials may be use in conjunction with the warning ground lighting system of the invention.

Having sufficiently described the nature of the present invention, it is stated that insofar as its basic principle is not altered, changed or modified it may be subjected to variations of detail. In this regard, we would highlight that the connection structure for connecting the supporting rod and the ground stake may vary. Numerous variations and modifications that are easily obtainable by means of the skilled person's common knowledge without departing from the scope of the invention should fall into the scope of this invention.

What is claimed is:

1. A warning ground lighting system comprising a controller, two groups of light strings each group having a plurality of light strings, and conducting wires connecting said controller and said two groups of light strings, characterized in that said light system further comprises
a plurality of hollow supporting rods, each supporting rod serving for supporting a light holder which is connected with a light cap in a buckling manner, and
wherein the conducting wires bring a plurality of lights together in series to form a light string in each group which is then positioned within the supporting rod and the light holder.

2. The lighting system as claimed in claim 1, characterized in that the supporting rod is linked to a ground stake via a joggle.

3. The lighting system as claimed in claim 1, characterized in that a circuit of the lighting system is constructed by multiple output terminals of the controller coupled in parallel to the two groups of light strings with opposite phase order connected together.

4. The lighting system as claimed in claim 3, characterized in that each group of light strings includes eight light strings, the controller has four output terminals, wherein every two strings in each group are connected each other in series and subsequently connected in parallel respectively and successively between one of the four output terminals of the controller and the zero line.

5. The lighting system as claimed in claim 4, characterized in that each light string has ten lights and the two groups of light strings synchronize their light-generation in the same direction or in the opposite direction.
